(19) United States
(12) Patent Application Publication
(10) Pub. No.: US 2026/0276775 A1
(43) Pub. Date: Sep. 17, 2026

(54) TECHNOLOGIES FOR MONITORING TIRE PRESSURE OF A VEHICLE

(71) Applicant: CalAmp Corp., Carlsbad, CA (US)

(72) Inventors: Christopher Adams, Carlsbad, CA (US); Robert Bradshaw, Carlsbad, CA (US)

(21) Appl. No.: 19/080,072

(22) Filed: Mar. 14, 2025

(51) Int. Cl. G01S 5/02; B60C 23/04; G01M 17/02; G07C 5/00

(52) U.S. Cl. CPC G01S 5/0269; B60C 23/0416; B60C 23/0479; G01M 17/02; G07C 5/008

(57) ABSTRACT

Technologies for monitoring tire pressure of a vehicle includes a plurality of tire pressure sensors and a telematics gateway. Each tire sensor is configured to measure a pressure of a corresponding tire of the vehicle. The vehicle has plurality of tires grouped into tire sets at different locations on the vehicle. The telematics gateway is configured to a distance to each tire pressure sensor based on a received distance communication from the respective tire pressure sensor and determine a tire set of the plurality of tires to which each tire pressure sensor belongs based on the determined distance to the respective tire pressure sensor. The telematics gateway also determines a location of each tire pressure sensor within a set of tire pressure sensors based on received distances between tire pressure sensors located on lateral opposite sides of the vehicle.

### FIELD OF THE DISCLOSURE

The present disclosure relates generally to telematics and associated telematics devices and, more particularly, to a telematics system for monitoring tire pressure of tires of a vehicle.

### BACKGROUND

Telematics involves the integrated use of telecommunications and informatics, particularly for application in vehicles and other assets. Telematics functionality may include, but is not limited to, recording vehicle information, emergency warning systems, crash prediction and detection, navigation functionality, safety warnings, fleet and asset management, and automated driving assistance. Vehicle telematics devices may process and transmit telematics data and other messages generated by a vehicle and connected devices. For example, the telematics data may be produced by sensors, controllers, and/or other peripheral devices located on the vehicle and/or within the telematics device itself.

Vehicle telematics devices may be used, for example, to monitor various operational characteristics of the vehicle and/or accessory (e.g., tires) of the vehicle. To do so, telematics devices typically monitor sensor data produced by associated sensors located on the vehicle or the vehicle accessory. However, it can be difficult for a telematics device to maintain the location and identity of each sensor, unless that data is preprogrammed or “hardcoded” into the system. Such solutions, however, are not resilient to change or modification to the vehicle, such as replacement of the accessories and associated sensors.

### SUMMARY

According to an aspect of the present disclosure, a telematics system for monitoring tire pressure of vehicle may include a plurality of tire pressure sensors and a telematics gateway. Each tire pressure sensor may be configured to measure a pressure of a corresponding tire of the vehicle. The vehicle may have a plurality of tires grouped into tire pairs at different locations on the vehicle. The telematics gateway may be configured to communicate with the plurality of tire pressure sensors to request a distance communication from each tire pressure sensor and determine a distance to each tire pressure sensor based on a received distance communication from the respective tire pressure sensor. Additionally, the telematics gateway may be configured to determine a tire pair of the plurality of tires to which each tire pressure sensor belongs based on the determined distance to the respective tire pressure sensor.

In some embodiments, to determine the tire pair of the plurality of tires to which each tire pressure sensor belongs may include to group the tire pressure sensors into pairs of tire pressure sensors based on the received distance communications from the plurality of tire pressure sensors. For example, to group the tire pressure sensors into pairs of tire pressure sensors may include to rank the tire pressure sensors in order of the determined distance to each tire pressure sensor.

Additionally, in some embodiments, to group the tire pressure sensors into pairs of tire pressure sensors may further include to group a first pair of the plurality of tire pressure sensors having the two shortest determined distances to a first group. For example, the telematics gateway is mounted toward a side of the vehicle. In such embodiments, to determine the tire pair of the plurality of tires to which each tire pressure sensor belongs further may include to assign the first group to a front tire pair of the same side of the vehicle toward which the telematics gateway is mounted. Additionally or alternatively, to group the tire pressure sensors into pairs of tire pressure sensors further may include to group a second pair of the plurality of tire pressure sensors having the next two shortest determined distances to a second group. For example, to determine the tire pair of the plurality of tires to which each tire pressure sensor belongs may further include to assign the second group to a front tire pair of the opposite side of the vehicle toward which the telematics gateway is mounted. Additionally or alternatively, to group the tire pressure sensors into pairs of tire pressure sensors may further include to group a third pair of the plurality of tire pressure sensors having the two longest determined distances to a third group. For example, to determine the tire pair of the plurality of tires to which each tire pressure sensor belongs may further include to assign the third group to a rear tire pair of the opposite side of the vehicle toward which the telematics gateway is mounted. Additionally or alternatively, to group a fourth pair of the plurality of tire pressure sensors having the next longest determined distances to a fourth group. For example, to determine the tire pair of the plurality of tires to which each tire pressure sensor belongs may further include to assign the fourth group to a rear tire pair of the same side of the vehicle toward which the telematics gateway is mounted.

In some embodiments, the telematics gateway may be further configured to communicate with each tire pressure sensor of the plurality of tire pressure sensors to instruct each tire pressure sensor to determine a distance from the respective tire pressure sensor to each tire pressure sensor of a tire pair located on a laterally opposite side of the vehicle from the respective tire pressure sensor. In such embodiments, the telematics gateway may be configured to determine a location of each respective tire pressure sensor relative to another tire pressure sensor of the same pair of tire pressure sensors to which the respective tire pressure belongs based on the distance received from the respective tire pressure sensor to each tire pressure sensor of the tire pair located on the laterally opposite side of the vehicle from the respective tire pressure sensor.

Additionally, in some embodiments, the plurality of tire pressure sensors may include a first pair of tire pressure sensors belonging to a first pair of tires and a second pair of tire pressure sensors belong to a second pair of tires located on a side of the vehicle that is opposite from the side on which the first pair of tires is located. Each first pair and second pair of tire pressure sensors may include an outer tire pressure sensor and an inner tire pressure sensor located toward a centerline of the vehicle relative to the corresponding outer tire pressure sensor. In such embodiments, the telematics gateway may be configured to determine whether each tire pressure sensor of the first pair of tire pressure sensors is the outer tire pressure sensor or the inner tire pressure sensor based on the distance from each tire pressure sensor of the first pair of tire pressure sensors to each tire pressure sensor of the second pair of tire pressure sensors and from each tire pressure sensor of the second pair of tire pressure sensors to each tire pressure sensor of the first pair of tire pressure sensors. For example, to determine whether each tire pressure sensor of the first pair of tire pressure sensors is the outer tire pressure sensor or the inner tire pressure sensor may include to assign a first tire pressure sensor of the first pair as the outer tire pressure sensor of the first pair of tire pressure sensors in response to the distance from the first tire pressure sensor to one of the tire pressure sensors of the second pair of tire pressures sensors being the longest distance between each of the tire pressure sensors of the first pair and the second pair of tire pressure sensors.

According to another aspect of the present disclosure, a method for monitoring tire pressure of vehicle having a plurality of tires grouped into tire pairs at different locations on the vehicle may include communicating, from a telematics gateway to each tire pressure sensor of a plurality of tire pressure sensors, to request a distance communication form each tire pressure sensor and determining, by the telematics gateway, a distance to each tire pressure sensor based on the received distance communication from the respective tire pressure sensor. The method may also include determining, by the telematics gateway, a tire pair of the plurality of tires to which each tire pressure sensor belongs based on the determined distance to the respective tire pressure sensor.

In some embodiments, determining the tire pair of the plurality of tires to which each tire pressure sensor belongs may include grouping, by the telematics gateway, the tire pressure sensors into pairs of tire pressure sensors based on the received distance communications from the plurality of tire pressure sensors grouping, by the telematics gateway, ranking the tire pressure sensors in order of the determined distance to each tire pressure sensor.

Additionally, in some embodiments, grouping the tire pressure sensors into pairs of tire pressure sensors may include grouping, by the telematics gateway, a first pair of the plurality of tire pressure sensors having the two shortest determined distances to a first group; grouping, by the telematics gateway, a second pair of the plurality of tire pressure sensors having the next two shortest determined distances to a second group; grouping, by the telematics gateway, a third pair of the plurality of tire pressure sensors having the two longest determined distances to a third group; and grouping, by the telematics gateway, a fourth pair of the plurality of tire pressure sensors having the next longest determined distances to a fourth group. For example, the telematics gateway may be mounted toward a side of the vehicle. In such embodiments, to determine the tire pair of the plurality of tires to which each tire pressure sensor belongs may further include assigning, by the telematics gateway, the first group to a front tire pair of the same side of the vehicle toward which the telematics gateway is mounted; assigning, by the telematics gateway, the second group to a front tire pair of the opposite side of the vehicle toward which the telematics gateway is mounted; assigning, by the telematics gateway, assign the third group to a rear tire pair of the opposite side of the vehicle toward which the telematics gateway is mounted; and assigning, by the telematics gateway, assign the fourth group to a rear tire pair of the same side of the vehicle toward which the telematics gateway is mounted.

In some embodiments, the method may further include communicating, by the telematics gateway, with each tire pressure sensor of the plurality of tire pressure sensors to instruct each tire pressure sensor to determine a distance from the respective tire pressure sensor to each tire pressure sensor of a tire pair located on a laterally opposite side of the vehicle from the respective tire pressure sensor. Additionally, the method may include determining, by the telematics gateway, a location of each respective tire pressure sensor relative to another tire pressure sensor of the same pair of tire pressure sensors to which the respective tire pressure belongs based on the distance received from the respective tire pressure sensor to each tire pressure sensor of the tire pair located on the laterally opposite side of the vehicle from the respective tire pressure sensor.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a system for monitoring tire pressure of a vehicle including a telematics device, a telematics gateway, and a set of tire pressure sensors;

FIG. 2 is a simplified block diagram of at least one embodiment of a tire pressure sensor of the system of FIG. 1;

FIG. 3 is a simplified diagram of the system of FIG. 1 installed in a tractor trailer with each tire pressure sensor coupled to a tire of a trailer of the tractor trailer;

FIG. 4 is a simplified diagram of an inaccurate mounting location of the telematics gateway of the system of FIG. 1 relative to the tire pressure sensors;

FIG. 5 is a simplified diagram of another inaccurate mounting location of the telematics gateway of the system of FIG. 1 relative to the tire pressure sensors;

FIGS. 6A-6C are a simplified flow diagram of at least one embodiment of a method for determining a location of the tire pressure sensors of the system of FIG. 1 when installed on a vehicle as shown in FIG. 3, which may be executed by the telematics gateway of the system of FIG. 1;

FIG. 7 is a simplified diagram of the tire pressure sensors of the system of FIG. 1 installed on a trailer in a misaligned configuration;

FIGS. 8A-8B are a simplified flow diagram of at least one embodiment of a method for reporting a location of the tire pressure sensors of the system of FIG. 1 when installed on a vehicle as shown in FIG. 3, which may be executed by the tire pressure sensors of the system of FIG. 1;

FIG. 9 is a simplified flow diagram of at least one embodiment of a method for determining tire pressure of a vehicle that may be executed by the telematics gateway of the system of FIG. 1; and

FIG. 10 is a simplified flow diagram of at least one embodiment of a method for determining tire pressure of a vehicle that may be executed by the tire pressure sensors of the system of FIG. 1.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C): (A and B); (B and C); or (A, B, and C). Similarly, items listed in the form of “at least one of A, B, or C” can mean (A); (B); (C): (A and B); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

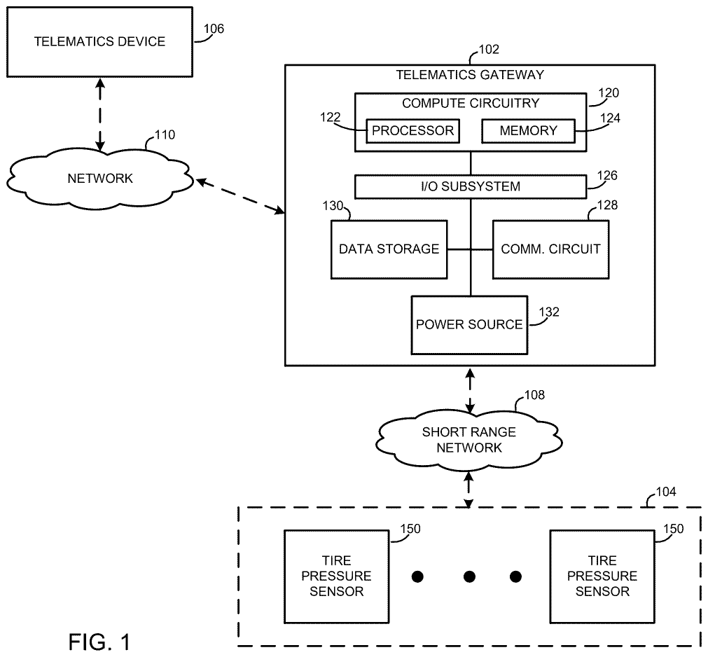

Referring now to FIG. 1, an illustrative telematics system 100 for monitoring tire pressure of a vehicle includes a telematics gateway 102, a set 104 of tire pressure sensors 150, and a telematics device 106. The system 100 also includes a short range network 108 over which the telematics gateway 102 and the tire pressure sensors 150 communicate and a network 110 over which the telematics gateway 102 and the telematics device 106 communicate. In some embodiments, the network 110 may be embodied as the same network as the short range network 108.

In use, as discussed in more detail below, the telematics gateway 102 is configured to determine a location on a vehicle of each of the tire pressure sensors 150 of the set 104. More specifically, the telematics gateway 102 is configured to determine which tire of the vehicle each tire pressure sensor 150 is coupled to or otherwise belongs to. For example, in embodiments in which the vehicle is embodied as a trailer, the vehicle may include multiple sets of tires, such as four pairs of tires. In such embodiments, the telematics gateway 102 is configured to determine which tire of which pair of tires each tire pressure sensor 150 is coupled to or otherwise belongs. To do so, the telematics gateway 102 is configured to communicate with each tire pressure sensor 150 to determine a distance to each respective tire pressure sensor 150. Based on the determined distance from the telematics gateway 102 to each tire pressure sensor 150, the telematics gateway 102 assigns each tire pressure sensor 150 to a set or pair of tires.

However, due to variability in the relative orientations of the tire pressure sensors 150, the mounting location of the telematics gateway 102, and the granularity of the distance data from the tire pressure sensors 150, the telematics gateway 102 may not be able to determine which tire pressure sensor 150 of the pair or set of tire pressure sensors 150 each respective tire pressure sensor 150 is (e.g., whether each tire pressure sensor is coupled to an inner tire or an outer tire of a pair of tires of the vehicle). As such, to more accurately determine the relative location of each tire pressure sensor 150 within its respective pair of tires (e.g., inner or outer location), the telematics gateway 102 is configured to instruct each tire pressure sensor 150 to communicate with each tire pressure sensor 150 of the pair of tire pressure sensors 150 located on the laterally opposite side of the vehicle from the respective tire pressure sensor 150 to determine the distance to those oppositely-located tire pressure sensors 150. That is, each tire pressure sensor 150 located on a left or driver side of a vehicle is configured to communicate with and determined the distance to each tire pressure sensor 150 of the pair or set of tire pressure sensors 150 located on the laterally opposite right or passenger side of the vehicle and vice versa (e.g., from a front-left pair to a front-right pair, from the front-right pair to the front-left pair, from a rear left-right pair to a rear right pair, and from the rear-right pair to the rear-left pair).

The telematics gateway 102 receives the distance data from each of the tire pressure sensors 150 and determines the location of each tire pressure sensor 150 within its pair or set (e.g., inner or outer location) based on the received distance data. For example, in the illustrative embodiment, for each laterally opposing set of pairs of tire pressure sensors 150, the telematics gateway 102 assigns the two tire pressures sensors 150 reporting the longest distance to each other as the outside tire pressure sensor 150 for their respective pair and the two tire pressure sensors 150 reporting the shortest distance to each other as the inside tire pressure sensor 150 for their respective pair. If the telematics gateway 102 is unable to determine the location of each tire pressure sensor 150 with a reference level of certainly (e.g., if a difference between reported distances is less than a reference threshold), the telematics gateway 102 may request certain confirmation actions be performed such as reconfirming the location assignments during travel of the vehicle.

The telematics gateway 102 may be embodied as any device or collection of devices capable of communicating with the tire pressure sensors 150 and the telematics device 106, determining the location of each tire pressure sensor 150 using the methodology described herein, and performing the other functionality described below. In the illustrative embodiment, the telematics gateway 102 includes compute circuitry 120, an I/O subsystem 126, a data storage 130, a communication circuit 128, and a power source 132. Of course, the telematics gateway 102 may include other or additional components, such as those commonly found in a portable or embedded computer (e.g., various input/output devices), in other embodiments. Additionally, in some embodiments, one or more of the illustrative components may be incorporated in, or otherwise form a portion of, another component.

The compute circuitry 120 may be embodied as any type of device or collection of devices capable of performing various compute functions. In some embodiments, the compute circuitry 120 may be embodied as a single device such as an integrated circuit, an embedded system, a field-programmable-array (FPGA), a system-on-a-chip (SOC), or other integrated system or device. Additionally, in some embodiments, the compute circuitry 120 includes or is embodied as a processor 122 and memory 124. The processor 122 may be embodied as any type of processor capable of performing the functions described herein. For example, the processor 122 may be embodied as a single or multi-core processor(s), digital signal processor, microcontroller, or other processor or processing/controlling circuit. Similarly, the memory 124 may be embodied as any type of volatile or non-volatile memory or data storage capable of performing the functions described herein. In operation, the memory 124 may store various data and software used during operation of the telematics gateway 102 such as operating systems, applications, programs, libraries, and drivers.

The compute circuitry 120 is communicatively coupled to other components of the telematics gateway 102 via the I/O subsystem 126, which may be embodied as circuitry and/or components to facilitate input/output operations with the compute circuitry 120 (e.g., with the processor 122 and/or memory 124) and other components of the telematics gateway 102. For example, the I/O subsystem 126 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations.

The data storage device 130 may be embodied as any type of device or devices configured for short-term or long-term storage of data such as, for example, memory devices and circuits, memory cards, hard disk drives, solid-state drives, or other data storage devices. The data storage device 130 may store various data including programs, scripts, location data, message data, and other types of digital data. For example, in some embodiments, the telematics gateway 102 may be configured to store identification data of each tire pressure sensor 150, along with the reported distance data related to each tire pressure sensor 150 as discussed in more detail below.

The communication circuit 128 of the telematics gateway 102 may be embodied as any type of communication circuit, device, or collection thereof, capable of enabling communications between the telematics gateway 102 and the tire pressure sensors 150 over the short range network 108 and between the telematics gateway 102 and the telematics device 106 over the network 110. To do so, the communication circuit 128 may utilize any suitable communication protocol. For example, the communication circuit 128 may be configured to use a short range communication protocol such as Bluetooth® Low Energy (BLE) protocol and associated technology to communicate with the tire pressure sensors 150 over the short range network 108. Additionally, the communication circuit 128 may be configured to use a long range communication protocol including, but not limited to Long-Term Evolution (LTE), 4G LTE, 5G, Wi-Fi (e.g., communications based on the Institute of Electrical and Electronics Engineers (IEEE) 802.11 family), Ethernet, Worldwide Interoperability for Microwave Access (WiMAX), Ethernet, Global System for Mobile Communications (GSM), and/or General Packet Radio Service (GPRS), to communicate with the telematics device 106 over the network 110. In some embodiments, the communication circuit 128 may utilize the same communication protocol to communicate with the tire pressure sensors 150 and the telematics device 106, such as a short range communication protocol (e.g., a Bluetooth® protocol). In such embodiments, the networks 108, 110 may be the same or similar networks.

The power source 132 may be embodied as any type of electrical power source capable of providing power to the other components of the telematics gateway 102. For example, the power source 132 may be embodied as a battery or similar independent power source. In some embodiments, the telematics gateway 102 may be configured to be wired to an external power source, such as the power source (e.g., battery) of the vehicle or trailer in which the telematics gateway 102 is installed. In such embodiments, the power source 132 may be embodied as or otherwise include a power connector or similar interconnect for interfacing with the external power source.

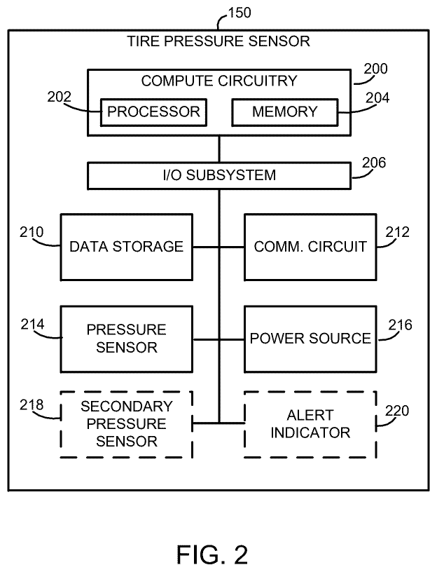

Referring now to FIG. 2, each tire pressure sensor 150 may be embodied as any electrical device capable of measuring or otherwise detecting the pressure within an associated tire of a vehicle and communicating with each other and the telematics gateway 102 as described below. In the illustrative embodiment, each tire pressure sensor 150 is configured to be secured to a valve stem of a corresponding tire of the vehicle to facilitate the measurement of the tire pressure of that tire. However, in other embodiments, the tire pressure sensors 150 may be configured to be located within the associated tire itself.

In the illustrative embodiment, each tire pressure sensor 150 includes compute circuitry 200, an I/O subsystem 206, a data storage 210, a communication circuit 212, a pressure sensor 214, and a power source 216. Additionally, in some embodiments, each tire pressure sensor 150 may also include a secondary pressure sensor 218 and/or an alert indicator 220. Of course, the tire pressure sensor 150 may include other or additional components, such as those commonly found in an electronic sensor module, in other embodiments. Additionally, in some embodiments, one or more of the illustrative components may be incorporated in, or otherwise form a portion of, another component. For example, in the illustrative embodiment, each of the compute circuity 200, the I/O subsystem 206, and the communication circuit 212 are grouped together in a wireless modem or radio module.

The compute circuitry 200 may be embodied as any type of device or collection of devices capable of performing various compute functions. In some embodiments, the compute circuitry 200 may be embodied as a single device such as an integrated circuit, an embedded system, a field-programmable-array (FPGA), a system-on-a-chip (SOC), or other integrated system or device. Additionally, in some embodiments, the compute circuitry 200 includes or is embodied as a processor 202 and memory 204. The processor 202 may be embodied as any type of processor capable of performing the functions described herein. For example, the processor 202 may be embodied as a single or multi-core processor(s), digital signal processor, microcontroller, or other processor or processing/controlling circuit. Similarly, the memory 204 may be embodied as any type of volatile or non-volatile memory or data storage capable of performing the functions described herein. In operation, the memory 204 may store various data and software used during operation of the tire pressure sensor 150 such as operating systems, applications, programs, libraries, and drivers.

The compute circuitry 200 is communicatively coupled to other components of the tire pressure sensor 150 via the I/O subsystem 206, which may be embodied as circuitry and/or components to facilitate input/output operations with the compute circuitry 200 (e.g., with the processor 202 and/or memory 204) and other components of the telematics gateway 102. For example, the I/O subsystem 206 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations.

The data storage device 210 may be embodied as any type of device or devices configured for short-term or long-term storage of data such as, for example, memory devices and circuits, memory cards, hard disk drives, solid-state drives, or other data storage devices. The data storage device 210 may store various data including programs, scripts, location data, message data, and other types of digital data. For example, in some embodiments, the tire pressure sensor 150 may be configured to store identification data that uniquely identifies the tire pressure sensor 150 from other tire pressure sensor 150, tire pressure data captured over time, and distance data indicative of the distance to other tire pressure sensors 150 as discussed below.

The communication circuit 212 of the tire pressure sensor 150 may be embodied as any type of communication circuit, device, or collection thereof, configured for communication over a relative short distance, such as over a wireless personal area network (PAN). In doing so, the communication circuit 212 may utilize any suitable short range communication protocol. In the illustrative embodiment, the communication circuit 212 is embodied as a Bluetooth® communication device configured to use Bluetooth® Low Energy (BLE) protocol and associated technology to facilitate communications over the short range network 108.

The pressure sensor 214 may be embodied as any type of sensor capable of measuring or otherwise detecting a pressure within an associated tire and generating sensor data indicative of the measured pressure. In the illustrative embodiment, the pressure sensor 214 is co-located with the other components of the tire pressure sensor 150 (e.g., within a common housing coupled to a valve stem of the associated tire). However, in other embodiments, the pressure sensor 214 may be separate from, but communicatively coupled to, the other components of the tire pressure sensor 150. For example, the pressure sensor 214 may be located within the associated tire while the other components of the tire pressure sensor 150 are located external to the tire (e.g., attached to the valve stem).

The power source 216 may be embodied as any type of electrical power source capable of providing power to the other components of the tire pressure sensor 150. For example, the local power source 334 may be embodied as a battery or similar independent power source.

In some embodiments, each tire pressure sensor 150 may be configured to measure the tire pressure of multiple tires. For example, the tire pressure sensor 150 may be fluidly connected to two or more tires via associated tubing or other interconnects. In such embodiments, the tire pressure sensor 150 may include a secondary (or more) pressure sensor 218. The secondary pressure sensor 218 may be substantially similar to the pressure sensor 214 and may be local to the other components of the tire pressure sensor 150 or located remotely therefrom. For example, in some embodiments, the secondary pressure sensor 218 may be attached to a valve stem of another tire and electrically connected to the other components of the tire pressure sensor 150 such that a single tire pressure sensor 150 is capable of monitoring the tire pressure of multiple associated tires.

Additionally, in some embodiments, each tire pressure sensor 150 may include an alert indicator 220. The alert indicator may be embodied as any type of indicator capable of generating an alert signal. For example, in the illustrative embodiment, the alert indicator 220 is embodied as a light emitting diode configured to generate a visual alert in response to activation. However, in other embodiments, the alert indicator 220 may include or otherwise be embodied as an audible indicator configured to generate an audible alert or other type of indicator.

Referring now back to FIG. 1, the telematics device 106 may be embodied as any type of device or collection of devices capable of monitoring various characteristics of an associated vehicle (e.g., location, movement, operational characteristics, etc.) and communicating with the telematics gateway 102 and, in some embodiments, a remote server (not shown) such as a remote management server, fleet management computer, asset owner management server, a telematics server, a data analytics server, and/or other type of remote computer device or system. The telematics device 106 may include components commonly found in telematics devices such as compute circuitry, data storage, and communication circuits. In use, the telematics device 106 is configured to communicate with the telematics gateway 102 to receive tire pressure data of each associated tire as reported from the tire pressure sensors. The telematics device 106 may be configured to analyze the tire pressure data locally and/or to transmit the tire pressure data to the remove server (not shown). For example, in some embodiments, the telematics device 106 may be configured to generate reports based on the tire pressure data and/or generate alerts to a driver of the associated vehicle based on the receive tire pressure data.

The short range network 108 may be embodied as any type of network capable of facilitating short range communications between the telematics gateway 102 and the tire pressure sensors 150. In the illustrative embodiment, the short range network 108 is embodied as an ad hoc, wireless personal area network (PAN) configured to support Bluetooth® Low Energy (BLE) communication protocols.

The network 110 may be embodied as any type of network capable of facilitating short range communications between the telematics gateway 102 and the telematics device 106. In some embodiments, the network 110 may be identical to the short range network 108 or even the same network. In other embodiments, the network 110 may be embodied as a long range network such as a cellular network, a publicly-accessible, global network such as the Internet, a wireless wide area network (WAN), and/or other network or other data communication infrastructure. In such embodiments, the network 110 may facilitate various data communication specifications and/or protocols including, but not limited to, Long-Term Evolution (LTE), 4G LTE, 5G, Wi-Fi (e.g., communications based on the Institute of Electrical and Electronics Engineers (IEEE) 802.11 family), Worldwide Interoperability for Microwave Access (WiMAX), Ethernet, Global System for Mobile Communications (GSM), and/or General Packet Radio Service (GPRS). As such, the network 110 may include any number of additional devices, such as additional computers, routers, stations, and switches, to facilitate such communications among the telematics device 106 and the telematics gateway 102.

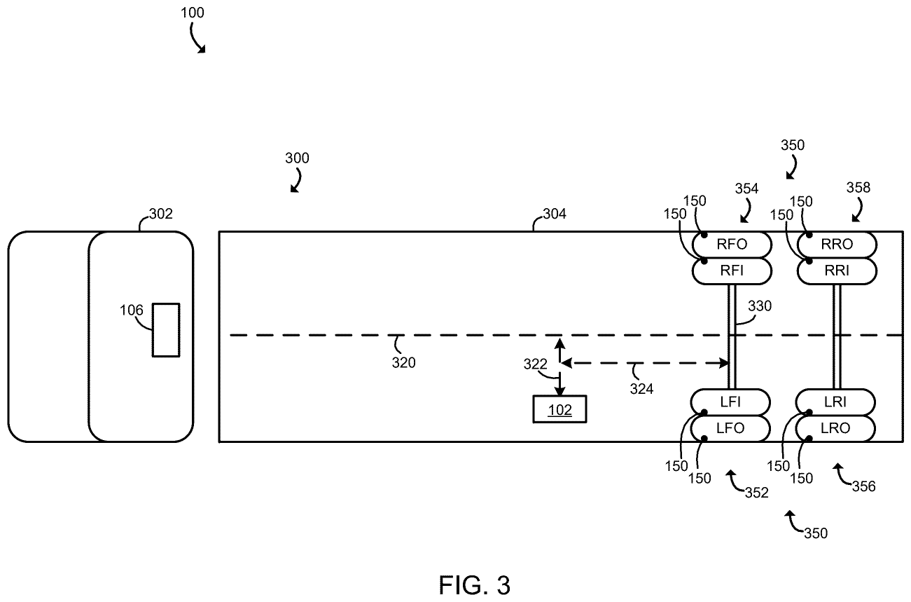

Referring now to FIG. 3, in use, the system 100 is configured to be installed into a vehicle 300 such as a tractor trailer having multiple tire pairs or sets 350. For example, in the illustrative embodiment, the tire pairs 350 of the tractor trailer 300 includes a left-front pair 352 of tires including a left-front-outer tire (LFO) and a left-front-inner tire (LFI), a right-front pair 354 of tires including a right-front-outer tire (RFO) and a right-front-inner tire (RFI), a left-rear pair 356 of tires including a left-rear-outer tire (LRO) and a left-rear-inner tire (LRI), and a right-rear pair 358 of tires including a right-rear-outer tire (RRO) and a right rear inner tire (RRI). Of course, in other embodiments each set of tires 350 may include more than two tires.

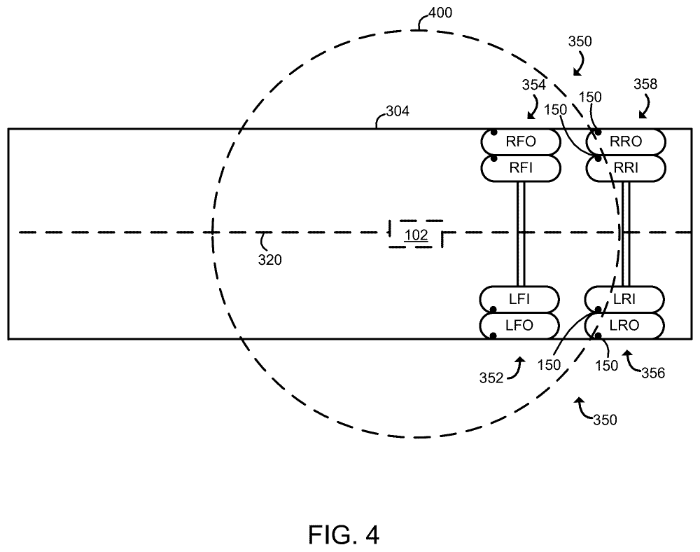

As discussed above, a tire pressure sensor 150 is coupled to each tire of the tire pairs 350 to measure an amount of tire pressure of each corresponding tire (LFO, LFI, RFI, RFO, LRO, LRI, RRI, and RRO). Additionally, in the illustrative embodiment, the telematics device 106 may be mounted or installed in a cab 302 of the tractor trailer 300, while the telematics gateway 102 is mounted on or installed in a trailer 304 of the tractor trailer 300. However, the mounting location of the telematics gateway 102 on the trailer 304 can affect the accuracy and ability of the telematics gateway 102 to determine the location of the tire pressure sensors 150 of each tire pair 350. In particular, as shown in FIG. 3, the telematics gateway 102 is mounted a lateral distance 322 offset from a centerline 320 of the tractor trailer 300, which allows the telematics gateway 102 to differentiate the distances reported from the tire pressure sensors 150 of the left-side tire pairs 350 (LFO, LFI, LRO, LRI) and from the right-side tire pairs 350 (RFO, RFI, RRO, RRI). For example, as shown in FIG. 4, if the telematics gateway 102 is mounted on the centerline 320 of the tractor trailer 300, the telematics gateway 102 is located substantially equidistant from each of the left-rear pair 356 (LRO, LRI) of tire pairs 350 and from the right-rear pair 358 (RRO, RRI) of tire pairs 350 as indicated by the distance circle 400 in FIG. 4. As such, the distance communications received from each tire pressure sensor 150 on each side would be too similar or even identical, making the determination of the location of each individual tire pressure sensor 150 (e.g., which side tire pair 352, 356 or 354, 358 each tire pressure sensor 150 belongs too) difficult or impossible.

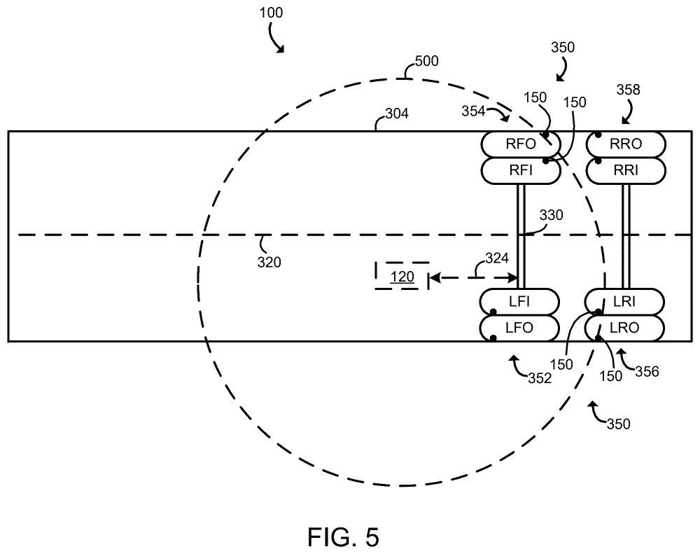

Referring back to FIG. 3, the telematics gateway 102 is additionally mounted a longitudinal distance 324 from the axle 330 of the front tire pairs 350 that is great enough to allow the telematics gateway 102 to differentiate the distances reported from the tire pressure sensors 150 of the front tire pairs 350 (left-front pair 352 (LFO, LFI) and right-front pair 354 (RFI, RFO)) relative to the rear tire pairs 350 (left-rear pair 356 (LRO, LRI) and right-rear pair 358 (RRI, RRO). For example, as shown in FIG. 5, if the longitudinal distance 324 between the mounting location of the telematics gateway 102 and the axle 330 of the front tire pairs 350 (left-front pair 352 and right-front pair 354) is too short, the telematics gateway 102 may be located substantially equidistant from the left-rear pairs 356 and the right-front pairs 354 of tire pairs 350 as indicated by the distance circle 500 or from the left-front pair 352 and the right-rear pair 358 depending on which side of the centerline 320 the telematics gateway 102 is mounted, making the determination of the location of each individual tire pressure sensor 150 difficult or impossible.

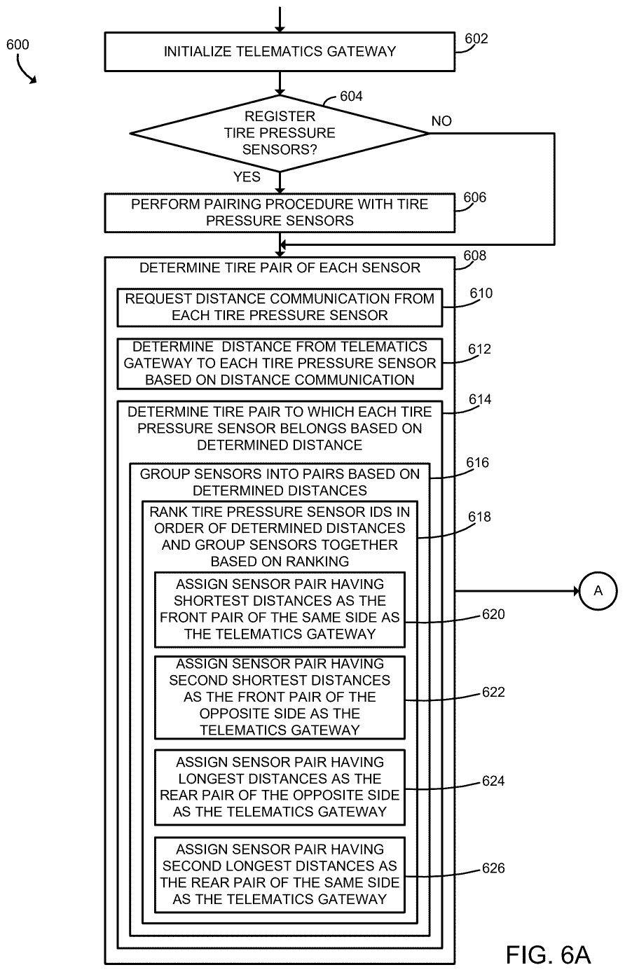

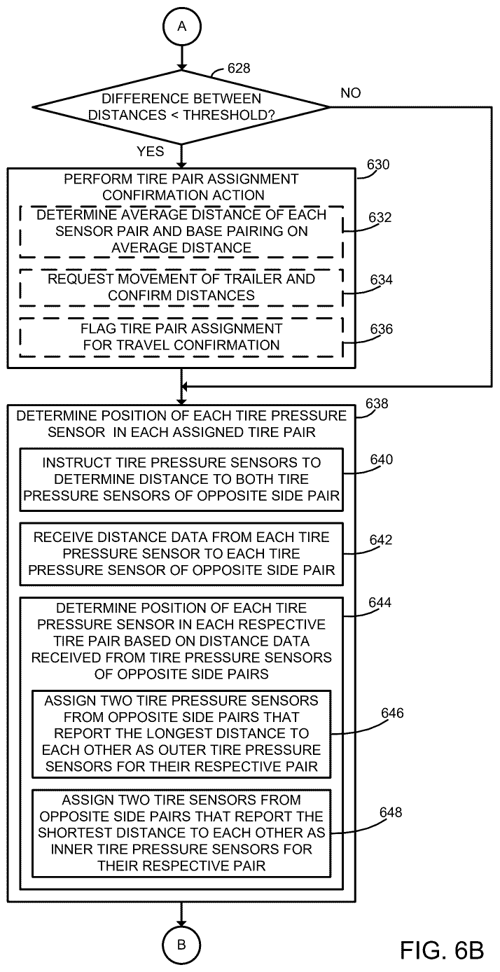

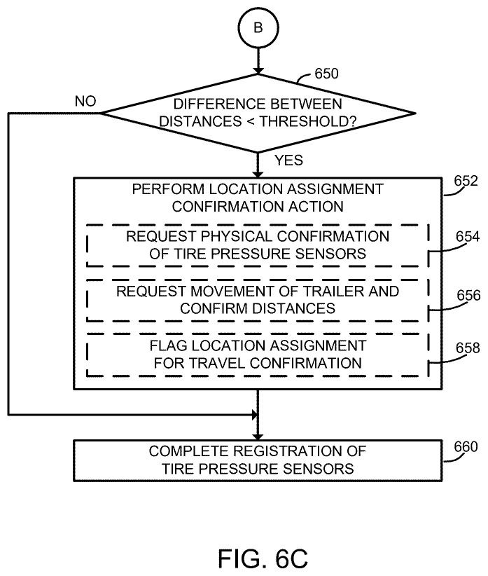

Referring now to FIGS. 6A-6C, in use, the telematics gateway 102 is configured to execute a method 600 for determining a location of each tire pressure sensor 150. The method 600 begins with block 602 in which the telematics gateway 102 is initialized. For example, the telematics gateway 102 may perform certain validity checks, establish communications with the telematics device 106, and/or perform other initialization procedures. After the telematics gateway 102 has been initialized in block 602, the method 600 advances to block 604 in which the telematics gateway 102 determines whether to register any tire pressure sensor 150. For example, during the initial installation of the system 100, each tire pressure sensor 150 may be registered with the telematics gateway 102. Additionally, as tire pressure sensors 150 (or tires to which the tire pressure sensors 150 are attached) are replaced, the new tire pressure sensor 150 may be registered with the telematics gateway 102.

If the telematics gateway 102 determines to register one or more tire pressure sensors 150 in block 604, the method 600 advances to block 606. In block 606, the telematics gateway 102 performs a pairing procedure with each tire pressure sensor 150 to be registered. Any suitable pairing procedure may be used in block 606. In doing so, in the illustrative embodiment, each tire pressure sensor 150 is configured to transmit sensor identification data that uniquely identifies that tire pressure sensor 150 from other tire pressure sensors 150 of the system 100 to the telematics gateway 102, which locally stores the identification data as part of block 606.

Subsequently, in block 608, the telematics gateway 102 determines which tire pair 352, 356, 354, 358 of the tire pairs 350 to which each tire pressure sensor 150 belongs. That is, the telematics gateway 102 determines whether each tire pressure sensor 150 is attached to a tire of the left-front pair 352 (LFO or LFI), the right-front pair 354 (RFO, RFI), the left-rear pair 356 (LRO, LRI), or the right-rear pair 358 (RRO, RRI). To do so, in block 610, the telematics gateway 102 requests a distance communication from each tire pressure sensor 150 and subsequently determines the distance to each tire pressure sensor 150 based on the received distance communication. Depending on the short range communication protocol used by the telematics gateway 102 and the tire pressure sensor 150, various technologies and communication protocols may be used to determine distances between the telematics gateway 102 and the tire pressure sensors 150. For example, in some embodiments, telematics gateway 102 may be configured use the Received Signal Strength Indicator (RSSI) of the distance communication received from each tire pressure sensor 150 to determine the respective distance. In other embodiments, the telematics gateway 102 may use Angle of Arrival (AoA) or a dedicated ranging protocol.

Regardless, after the telematics gateway 102 has determined the distance to each tire pressure sensor 150 based on the received distance communication in block 612, the telematics gateway 102 determines the tire pair 352, 354, 356, 358 to which each tire pressure sensor belongs based on the determined distance in block 614. To do so, in block 616, the telematics gateway 102 is configured to group the tire pressure sensors 150 into pairs based on the determined distances. That is, in block 618, the telematics gateway 102 ranks the tire pressure sensor 150 in order of their determined distances as identified by their respective identification data. In block 620, the telematics gateway 102 assigns the two tire pressure sensors 150 reporting the shortest distances to the telematics gateway 102 as belonging to the front tire pair of the same side of the trailer 304 as the telematics gateway 102 (i.e., either tire pair 352 (LFO, LFI) or tire pair 354 (RFO, RFI)). In block 622, the telematics gateway 102 assigns the two tire pressure sensors 150 reporting the next shortest distances to the telematics gateway 102 as belonging to the front tire pair of the opposite side of the trailer 304 as the telematics gateway 102 (i.e., either tire pair 352 (LFO, LFI) or tire pair 354 (RFO, RFI)). In block 624, the telematics gateway 102 assigns the two tire pressure sensors 150 reporting the longest distances to the telematics gateway 102 as belonging to the rear tire pair of the opposite side of the trailer 304 as the telematics gateway 102 (i.e., either tire pair 356 (LRO, LRI) or tire pair 358 (RRO, RRI)). In block 626, the telematics gateway 102 assigns the two tire pressure sensors 150 reporting the next longest distances to the telematics gateway 102 as belonging to the rear tire pair of the same side of the trailer 304 as the telematics gateway 102 (i.e., either tire pair 356 (LRO, LRI) or tire pair 358 (RRO, RRI)).

In this way, the telematics gateway 102 is configured to determine which tire pair 350 each tire pressure sensor 150 belongs to based on the determined distances to each tire pressure sensor 150. However, in some situations and for various reasons, the determined distances may be so close in value that the determination of the pairing and assignment performed in block 608 may be prone to error. As such, in block 628, the telematics gateway 102 determines whether any determined distances between three or more tire pressure sensors 150 is less than a reference threshold. That is, tire pressure sensors 150 belonging to the same tire pair 350 will have similar determined distances but should have different distances from tire pressure sensors 150 of each other tire pair 350. As such, if three or more tire pressure sensors 150 have determined differences that are closer than the reference threshold amount, the confidence that each tire pressure sensor 150 is assigned to the correct tire pair 350 is reduced.

Accordingly, if the telematics gateway 102 determines that the distance difference between three or more tire pressure sensors 150 is less than the reference threshold value in block 628, the method 600 advances to block 630. In block 630, the telematics gateway 102 may perform one or more tire pair assignment confirmation actions to confirm the tire pair 350 to which each tire pressure sensor 150 was assigned. For example, in some embodiments in block 632, the telematics gateway 102 may be configured to average the determined distances between each assigned pair of tire pressure sensors 150 and confirm the assignment to the tire pairs 350 based on the averaged distances. Additionally or alternatively, in block 634, the telematics gateway 102 may be configured to request movement of the trailer 304, which resultantly changes the relative orientation of each tire pressure sensor 150 due to the rotation of the tire and associated valve stem to which each tire pressure sensor 150 is attached. The telematics gateway may repeat block 608 to again determine which tire pair 350 each tire pressure sensor 150 belongs using the new orientation of the tire pressure sensors 150. Further, in some embodiments in block 636, the telematics gateway 102 may be configured to flag the tire pair assignment for subsequent confirmation during the travel of the trailer 304. That is, the telematics gateway 102 may be configured to periodically perform the process of block 608 while the tractor trailer 300 is traveling or after the tractor trailer 300 has traveled a reference difference to thereby confirm the tire pair 350 assignment of each tire pressure sensor 150 until a level of confidence is reached in such assignments.

After the telematics gateway 102 has performed any confirmation action in block 630 or if no confirmation action is required, the method 600 advances to block 638. In block 638, the telematics gateway 102 is configured to determine the position (e.g., inner or outer) of each tire pressure sensor within its assigned tire pair 350. That is, while the telematics gateway 102 has assigned each tire pressure sensor 150 to a corresponding tire pair 350 (e.g., either tire pair 352 (LFO, LFI), tire pair 354 (RFO, RFI), tire pair 352 (LFO, LFI), or tire pair 354 (RFO, RFI)) in block 608, the reported distances to the telematics gateway 102 of each paired tire pressure sensor 150 are too similar in value to its paired tire pressure sensor 150 for the telematics gateway 102 to determine whether each tire pressure sensor 150 is the inner or the outer tire pressure sensor 150 of that tire pair 350. As such, in block 640, the telematics gateway 102 is configured to instruct each tire pressure sensor 150 to determine the distance to both tire pressure sensors 150 of the tire pair 350 located laterally across from the respective tire pressure sensor 150 (i.e., its opposite side pair). For example, the telematics gateway 102 instructs each tire pressure sensor of the tire pair 352 (LFO, LFI) to determine the distance to each tire pressure sensor 150 of the tire pair 354 (RFO, RFI) and vice versa. Similarly, the telematics gateway 102 instructs each tire pressure sensor of the tire pair 356 (LRO, LRI) to determine the distance to each tire pressure sensor 150 of the tire pair 358 (LRO, LRI) and vice versa. To do so, the tire pressure sensors 150 may utilize the same distance determination technology as used by the telematics gateway 102 described above in regard to block 612. In block 642, the telematics gateway 102 receives the distance data from each tire pressure sensor 150 to each tire pressure sensor 150 of the tire pair 350 located on the opposite side of the trailer 304. The received distance data may also include the identification of the two tire pressure sensors 150 to which the distance data belongs.

In block 644, the telematics gateway 102 is configured to determine the relative position (inner or outer) of each tire pressure sensor 150 in its respective tire pair 350 based on the distance data received from the tire pressure sensors 150 of the same opposite side pairs (i.e., the front group of tire pairs 352, 354 and the rear group of tire pairs 356, 358). As such, in the illustrative embodiment, the telematics gateway 102 is configured to analyze distance data from each individual group (front opposite side pairs and the rear opposite pairs) of different tire pressure sensors 150. In block 646, the telematics gateway 102 assigns the two tire pressure sensors 150 from the opposite side pairs (i.e., tire pairs 352, 354 or tire pairs 356, 358) that report the longest distance to each other as the outer tire pressure sensor 150 (i.e., the tire pressure sensor associated with LFO, RFO, LRO, or RRO tire) of its respective tire pair 350. Additionally, in block 648, the telematics gateway 102 assigns the two tire pressure sensors 150 from the opposite side pairs (i.e., tire pairs 352, 354 or tire pairs 356, 358) that report the shortest distance to each other as the inner tire pressure sensor 150 (i.e., the tire pressure sensor associated with LFI, RFI, LRI, or RRI tire) of its respective tire pair 350.

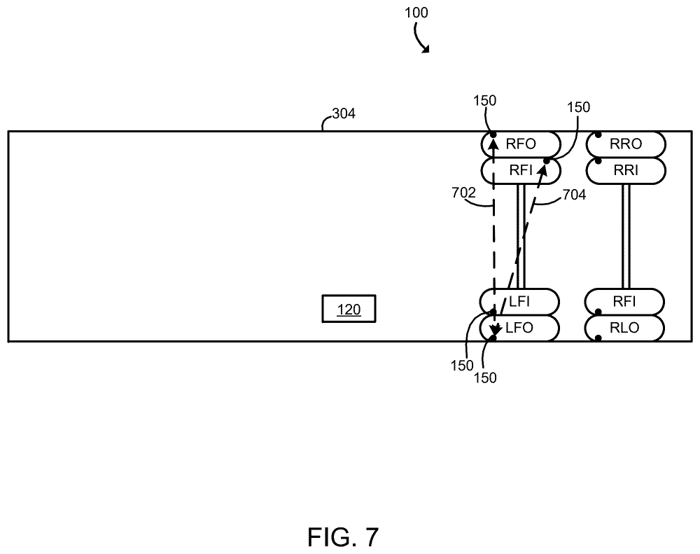

Again, however, it should be appreciated that in some situations, the determined distances reported by the tire pressure sensors 150 may be so close in values that the assignment of the individual location (inner or outer) of each tire pressure sensor 150 may be prone to error. For example, as shown in FIG. 7, the present orientation of each tire pressure sensor 150 on its respective tire can increase the difficulty in determining the relative location of each tire pressure sensor 150. If, as shown in FIG. 7, two of the tire pressure sensors 150 are 180 degrees shifted from each other in orientation, the distance 702 to the outer tire pressure sensor 150 (RFO in FIG. 7) of the opposite side tire pair 350 may be substantially the same as the distance 704 to the inner tire pressure sensor 150 (RFI in FIG. 7) of the opposite side tire pair 350. In such cases, the reported distances may be too close in value to discern which tire pressure sensor 150 is the inner or the outer tire pressure sensor 150 with any acceptable degree of certainty.

As such, in block 650, the telematics gateway 102 is configured to determine whether the two distances reported from any single tire pressure sensor 150 is less than a reference threshold amount. If so, the method 600 advances to block 652 in which the telematics gateway 102 may perform one or more tire pressure sensor 150 location assignment confirmation action. For example, in some embodiments in block 654, the telematics gateway 102 may request a physical confirmation of the tire pressure sensors 150. To do so, the telematics gateway 102 may individually instruct each tire pressure sensor 150 to active its alert indicator to confirm which tire pressure sensor 150 is which. Additionally or alternatively, in block 656, the telematics gateway 102 may be configured to request movement of the trailer 304, which resultantly changes the relative orientation of each tire pressure sensor 150 due to the rotation of the tire and associated valve stem to which each tire pressure sensor 150 is attached as discussed above. The telematics gateway 102 may repeat bock 638 to again determine the relative location (inner or outer) of each tire pressure sensor 150 using the new orientation of the tire pressure sensors 150. Further, in some embodiments in block 658, the telematics gateway 102 may be configured to flag the location assignment of each tire pressure sensor 150 for subsequent confirmation during the travel of the trailer 304. That is, the telematics gateway 102 may be configured to periodically perform the process of block 638 while the tractor trailer 300 is traveling or after the tractor trailer 300 has traveled a reference difference to thereby confirm the determined relative location (inner or outer) of each tire pressure sensor 150 until a level of confidence is reached in such assignments.

After the telematics gateway 102 performs the confirmation action in block 652 or if no action is required, the method 600 advances to block 660. In block 660, the telematics gateway 102 completes the registration of the tire pressure sensors 150. Once completed, the telematics gateway 102 may begin monitoring the individual tire pressure as reported by each tire pressure sensor 150.

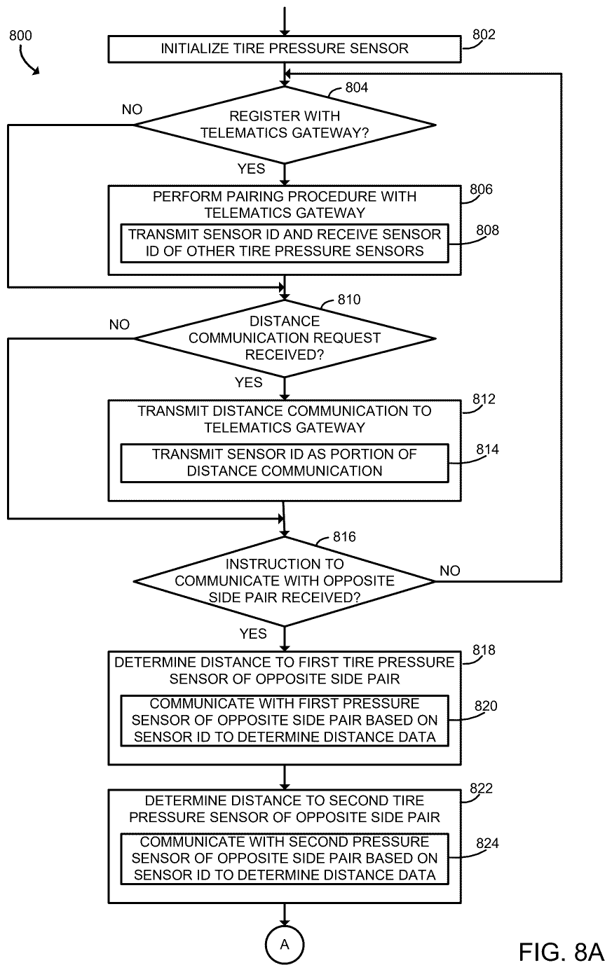

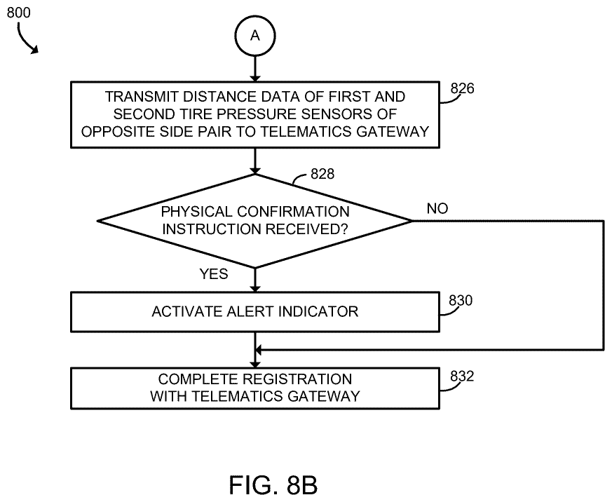

Referring now to FIGS. 8A-8B, in use, each tire pressure sensor 150 is configured to execute a method 800 for reporting a location of the respective tire pressure sensor 150. The method 800 begins with block 802 in which the tire pressure sensor 150 is initialized. For example, the tire pressure sensor 150 may perform certain validity checks, establish communications with the telematics gateway 102, and/or perform other initialization procedures. After the tire pressure sensor 150 has been initialized in block 802, the method 800 advances to block 804 in which the tire pressure sensor 150 determines whether to register with the telematics gateway 102. For example, during the initial installation of the system 100, each tire pressure sensor 150 may be registered with the telematics gateway 102 as discussed above. Additionally, if the present tire pressure sensor 150 is a new or replacement tire pressure sensor 150, the new tire pressure sensor 150 may register with the telematics gateway 102 in block 804.

If the tire pressure sensor 150 determines to register with the telematics gateway 102 in block 804, the method 800 advances to block 806. In block 806, the tire pressure sensor 150 performs a pairing procedure with the telematics gateway 102. Again, any suitable pairing procedure may be used. In doing so, in block 808, the tire pressure sensor 150 is configured to transmit its sensor identification data and receive sensor identification data of other tire pressure sensors 150 of the system 100.

Subsequently, in block 810, the tire pressure sensor 150 determines whether a distance communication request has been received from the telematics gateway 102. If so, the method 800 advances to block 812 in which the tire pressure sensor 150 is configured to transmit a distance communication to the telematics gateway 102. As discussed above, the distance communication may be embodied as any type of communication from which the telematics gateway 102 can determine the distance to the respective tire pressure sensor 150. In transmitting the distance communication, the tire pressure sensor 150 also transmits its sensor identification data in block 814.

After the tire pressure sensor 150 has transmitted the requested distance communication in block 812 or if no distance communication was requested, the method 800 advances to block 816. In block 816, the tire pressure sensor 150 determines whether an instruction to communicate with the opposite side pair of tire pressure sensors 150 has been received from the telematics gateway 102. As discussed above, the telematics gateway 102 is configured to request each tire pressure sensor 150 communicate with the each tire pressure sensor 150 of the opposite side pair (i.e., the pair of tire pressure sensors located on the lateral opposite side of the trailer 304) to determine the distance to each tire pressure sensor 150 of that opposite side pair.

If the tire pressure sensor 150 receives an instruction to communicate with the opposite side pair of tire pressure sensors 150 in block 816, the method 800 advances to block 818. In block 818, the tire pressure sensor 150 determines a distance to the first tire pressure sensor 150 of the opposite side pair of tire pressure sensors 150. To do so, in block 820, the tire pressure sensor 150 communicates with the first tire pressure sensor 150 of the opposite side pair using the sensor identification data received in block 814 to thereby determine distance data indicative of the distance from the respective tire pressure sensor 150 to the first tire pressure sensor 150 of the opposite side pair of tire pressure sensors 150. For example, if the respective tire pressure sensor 150 is one of the tire pressure sensors 150 of the left-front pair 352 (see FIG. 3), that tire pressure sensor 150 is configured to communicate with each tire pressure sensor 150 of the right-front pair 354 (i.e., RFO, RFI) to determine the distance to each of those tire pressure sensors 150. Similarly, if the respective tire pressure sensor 150 is one of the tire pressure sensors 150 of the right-rear pair 358, that tire pressure sensor 150 is configured to communicate with each tire pressure sensor 150 of the left-rear pair 356 (i.e., LRO, LRI) to determine the distance to each of those tire pressure sensors 150.

In block 822, the respective tire pressure sensor 150 determines a distance to the second tire pressure sensor 150 of the same opposite side pair of tire pressure sensors 150. To do so, in block 824, the tire pressure sensor 150 communicates with the second tire pressure sensor 150 of the opposite side pair using the sensor identification data received in block 814 to thereby determine distance data indicative of the distance from the respective tire pressure sensor 150 to the second tire pressure sensor 150 of the opposite side pair of tire pressure sensors. In this way, each tire pressure sensor 150 is configured to determine the distance to each tire pressure sensor of the opposite side pair of tire pressure sensors.

After the tire pressure sensor 150 has determined the distances to each tire pressure sensor 150 of the opposite side pair in blocks 818 and 822, the method 800 advances to block 826 of FIG. 8B. In block 826, the tire pressure sensor 150 transmits the distance data of the first and second tire pressure sensors 150 of the opposite side pair to the telematics gateway 102. Subsequently, in block 828, the tire pressure sensor 150 determines whether a physical confirmation instruction has been received from the telematics gateway 102. If so, the method 800 advances to block 830 in which the tire pressure sensor 150 is configured to activate the alert indicator 220. For example, the tire pressure sensor may activate a visual indicator to assist in confirmation of the assignment of each tire pressure sensor 150. The tire pressure sensor 150 subsequently completes the registration process with the telematics gateway 102.

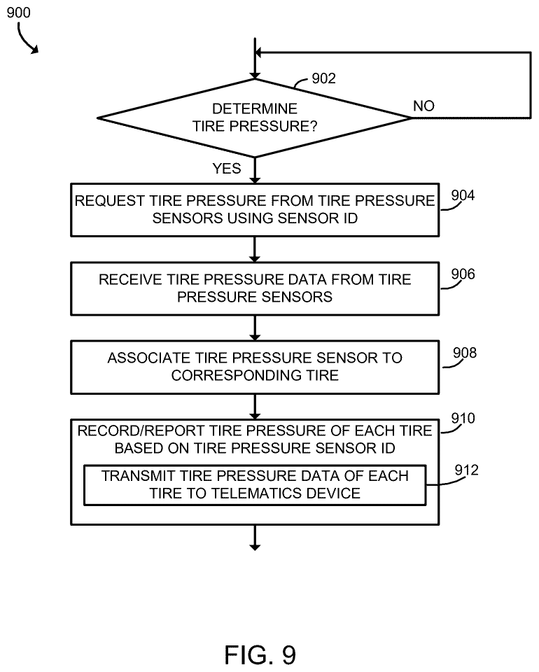

Referring now to FIG. 9, during operation, the telematics gateway 102 may execute a method 900 for determining the tire pressure of a tire of a vehicle to which the telematics gateway 102 is attached. The method 900 begins with block 902 in which the telematics gateway 102 determines whether to determine the tire pressure of one or more tires of the vehicle. If so, the method 900 advances to block 904 in which the telematics gateway 102 requests the tire pressure reading from the corresponding tire pressure sensor 150 using the sensor identification data for the tire pressure sensor 150. As discussed above, the telematics gateway 102 knows the location and associated tire of each tire pressure sensor 150 via execution of the method 600.

In block 906, the telematics gateway 102 receives the measured tire pressure from the corresponding tire pressure sensor 150. In block 908, the telematics gateway 102 associates the reporting tire pressure sensor 150 with the corresponding tire and, in block 910, records and/or reports the determined tire pressure of each tire based on the tire pressure sensor identification data. For example, in block 912, the telematics gateway 102 may transmit the tire pressure data to the telematics device 106 over the network 110. The telematics gateway 102 may be configured to periodically execute the method 900 to determine tire pressure of each tire. Additionally or alternatively, the telematics gateway 102 may be configured to execute the method 900 in response to receiving a request for tire pressure data from the telematics device 106 or other device of the system 100.

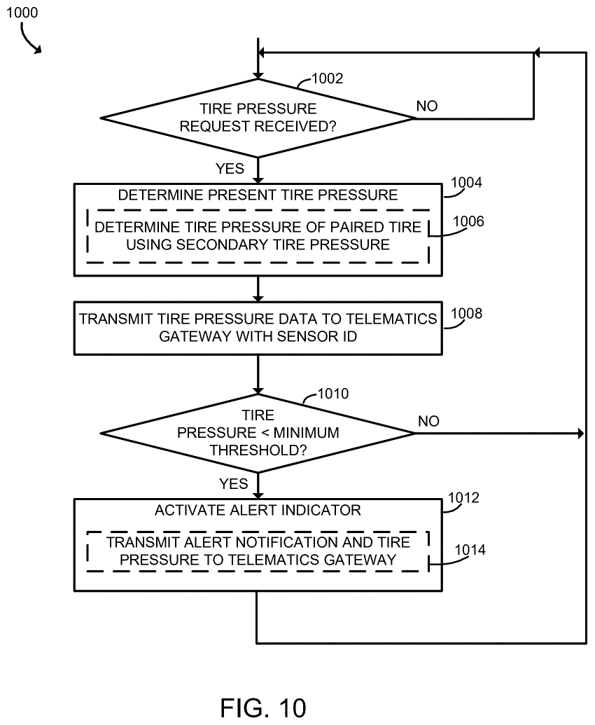

Referring now to FIG. 10, during operation, each tire pressure sensor 150 may be execute a method 1000 for determining the tire pressure of an associated tire of a vehicle. The method 1000 begins with block 1002 in which the tire pressure sensor 150 determines whether a request for a tire pressure reading has been received from the telematics gateway 102. If not, the method 1000 advances to block 1004 in which the tire pressure sensor 150 determines the present tire pressure of the tire to which the tire pressure sensor 150 is attached. Additionally, in those embodiments in which a single tire pressure sensor 150 monitors the tire pressure of one or more additional tires, the tire pressure sensor 150 may also determine the tire pressure of those additional tires in block 1006.

Subsequently, in block 1008, the tire pressure sensor 150 transmits the measured tire pressure(s) to the telematics gateway 102 using its sensor identification data. In block 1010, the tire pressure sensor 150 also determines whether the measure tire pressure is below a minimum threshold. If so, in block 1012, the tire pressure sensor 150 activates the alert indicator 220 to alert the operator of the vehicle that the associated tire is low on pressure. Additionally, in some embodiments, the tire pressure sensor 150 may be configured to transmit an alert notification regarding the low tire pressure to the telematics gateway 102.

While the disclosure has been illustrated and described in detail in the drawings and foregoing description, such an illustration and description is to be considered as illustrative and not restrictive in character, it being understood that only illustrative embodiments have been shown and described and that all changes and modifications that come within the spirit of the disclosure are desired to be protected.

There are a plurality of advantages of the present disclosure arising from the various features of the methods, apparatuses, and systems described herein. It will be noted that alternative embodiments of the methods, apparatuses, and systems of the present disclosure may not include all of the features described yet still benefit from at least some of the advantages of such features. Those of ordinary skill in the art may readily devise their own implementations of the methods, apparatuses, and systems that incorporate one or more of the features of the present invention and fall within the spirit and scope of the present disclosure as defined by the appended claims.

1. A telematics system for monitoring tire pressure of vehicle, the telematics system comprising:
a plurality of tire pressure sensors, wherein each tire pressure sensor is configured to measure a pressure of a corresponding tire of the vehicle, the vehicle having a plurality of tires grouped into tire pairs at different locations on the vehicle;
a telematics gateway configured to communicate with the plurality of tire pressure sensors to request a distance communication from each tire pressure sensor, determine a distance to each tire pressure sensor based on a received distance communication from the respective tire pressure sensor, and determine a tire pair of the plurality of tires to which each tire pressure sensor belongs based on the determined distance to the respective tire pressure sensor.

2. The telematics system of claim 1, wherein to determine the tire pair of the plurality of tires to which each tire pressure sensor belongs comprises to group the tire pressure sensors into pairs of tire pressure sensors based on the received distance communications from the plurality of tire pressure sensors.

3. The telematics system of claim 2, wherein to group the tire pressure sensors into pairs of tire pressure sensors comprises to rank the tire pressure sensors in order of the determined distance to each tire pressure sensor.

4. The telematics system of claim 3, wherein to group the tire pressure sensors into pairs of tire pressure sensors further comprises to group a first pair of the plurality of tire pressure sensors having the two shortest determined distances to a first group.

5. The telematics system of claim 4, wherein the telematics gateway is mounted toward a side of the vehicle, and
wherein to determine the tire pair of the plurality of tires to which each tire pressure sensor belongs further comprises to assign the first group to a front tire pair of the same side of the vehicle toward which the telematics gateway is mounted.

6. The telematics system of claim 4, wherein to group the tire pressure sensors into pairs of tire pressure sensors further comprises to group a second pair of the plurality of tire pressure sensors having the next two shortest determined distances to a second group.

7. The telematics system of claim 6, wherein the telematics gateway is mounted toward a side of the vehicle, and
wherein to determine the tire pair of the plurality of tires to which each tire pressure sensor belongs further comprises to assign the second group to a front tire pair of the opposite side of the vehicle toward which the telematics gateway is mounted.

8. The telematics system of claim 6, wherein to group the tire pressure sensors into pairs of tire pressure sensors further comprises to group a third pair of the plurality of tire pressure sensors having the two longest determined distances to a third group.

9. The telematics system of claim 8, wherein the telematics gateway is mounted toward a side of the vehicle, and
wherein to determine the tire pair of the plurality of tires to which each tire pressure sensor belongs further comprises to assign the third group to a rear tire pair of the opposite side of the vehicle toward which the telematics gateway is mounted.

10. The telematics system of claim 8, wherein to group the tire pressure sensors into pairs of tire pressure sensors further comprises to group a fourth pair of the plurality of tire pressure sensors having the next longest determined distances to a fourth group.

11. The telematics system of claim 9, wherein the telematics gateway is mounted toward a side of the vehicle, and
wherein to determine the tire pair of the plurality of tires to which each tire pressure sensor belongs further comprises to assign the fourth group to a rear tire pair of the same side of the vehicle toward which the telematics gateway is mounted.

12. The telematics system of claim 2, wherein the telematics gateway is further configured to communicate with each tire pressure sensor of the plurality of tire pressure sensors to instruct each tire pressure sensor to determine a distance from the respective tire pressure sensor to each tire pressure sensor of a tire pair located on a laterally opposite side of the vehicle from the respective tire pressure sensor.

13. The telematics system of claim 12, wherein the telematics gateway is configured to determine a location of each respective tire pressure sensor relative to another tire pressure sensor of the same pair of tire pressure sensors to which the respective tire pressure belongs based on the distance received from the respective tire pressure sensor to each tire pressure sensor of the tire pair located on the laterally opposite side of the vehicle from the respective tire pressure sensor.

14. The telematics system of claim 12, wherein the plurality of tire pressure sensors includes a first pair of tire pressure sensors belonging to a first pair of tires and a second pair of tire pressure sensors belong to a second pair of tires located on a side of the vehicle that is opposite from the side on which the first pair of tires is located, and wherein each first pair and second pair of tire pressure sensors includes an outer tire pressure sensor and an inner tire pressure sensor located toward a centerline of the vehicle relative to the corresponding outer tire pressure sensor, and
wherein the telematics gateway is configured to determine whether each tire pressure sensor of the first pair of tire pressure sensors is the outer tire pressure sensor or the inner tire pressure sensor based on the distance from each tire pressure sensor of the first pair of tire pressure sensors to each tire pressure sensor of the second pair of tire pressure sensors and from each tire pressure sensor of the second pair of tire pressure sensors to each tire pressure sensor of the first pair of tire pressure sensors.

15. The telematics system of claim 14, wherein to determine whether each tire pressure sensor of the first pair of tire pressure sensors is the outer tire pressure sensor or the inner tire pressure sensor comprises to assign a first tire pressure sensor of the first pair as the outer tire pressure sensor of the first pair of tire pressure sensors in response to the distance from the first tire pressure sensor to one of the tire pressure sensors of the second pair of tire pressures sensors being the longest distance between each of the tire pressure sensors of the first pair and the second pair of tire pressure sensors.

16. A method for monitoring tire pressure of vehicle having a plurality of tires grouped into tire pairs at different locations on the vehicle, the method comprising:
communicating, from a telematics gateway to each tire pressure sensor of a plurality of tire pressure sensors, to request a distance communication form each tire pressure sensor;
determining, by the telematics gateway, a distance to each tire pressure sensor based on the received distance communication from the respective tire pressure sensor; and
determining, by the telematics gateway, a tire pair of the plurality of tires to which each tire pressure sensor belongs based on the determined distance to the respective tire pressure sensor.

17. The method of claim 16, wherein determining the tire pair of the plurality of tires to which each tire pressure sensor belongs comprises:
grouping, by the telematics gateway, the tire pressure sensors into pairs of tire pressure sensors based on the received distance communications from the plurality of tire pressure sensors; and
grouping, by the telematics gateway, ranking the tire pressure sensors in order of the determined distance to each tire pressure sensor.

18. The method of claim 17, wherein grouping the tire pressure sensors into pairs of tire pressure sensors comprises:
grouping, by the telematics gateway, a first pair of the plurality of tire pressure sensors having the two shortest determined distances to a first group;
grouping, by the telematics gateway, a second pair of the plurality of tire pressure sensors having the next two shortest determined distances to a second group;
grouping, by the telematics gateway, a third pair of the plurality of tire pressure sensors having the two longest determined distances to a third group; and
grouping, by the telematics gateway, a fourth pair of the plurality of tire pressure sensors having the next longest determined distances to a fourth group.

19. The method of claim 18, wherein the telematics gateway is mounted toward a side of the vehicle, and wherein to determine the tire pair of the plurality of tires to which each tire pressure sensor belongs further comprises:
assigning, by the telematics gateway, the first group to a front tire pair of the same side of the vehicle toward which the telematics gateway is mounted;
assigning, by the telematics gateway, the second group to a front tire pair of the opposite side of the vehicle toward which the telematics gateway is mounted;
assigning, by the telematics gateway, assign the third group to a rear tire pair of the opposite side of the vehicle toward which the telematics gateway is mounted; and
assigning, by the telematics gateway, assign the fourth group to a rear tire pair of the same side of the vehicle toward which the telematics gateway is mounted.

20. The method of claim 19, further comprising:
communicating, by the telematics gateway, with each tire pressure sensor of the plurality of tire pressure sensors to instruct each tire pressure sensor to determine a distance from the respective tire pressure sensor to each tire pressure sensor of a tire pair located on a laterally opposite side of the vehicle from the respective tire pressure sensor; and
determining, by the telematics gateway, a location of each respective tire pressure sensor relative to another tire pressure sensor of the same pair of tire pressure sensors to which the respective tire pressure belongs based on the distance received from the respective tire pressure sensor to each tire pressure sensor of the tire pair located on the laterally opposite side of the vehicle from the respective tire pressure sensor.
